(19) United States
(12) Patent Application Publication
(10) Pub. No.: US 2020/0223635 A1
(43) Pub. Date: Jul. 16, 2020

(54) Warehouse Management System

(71) Applicant: Ganapathy Govindaswamy, Reston, VA (US)

(72) Inventor: Ganapathy Govindaswamy, Reston, VA (US)

(21) Appl. No.: 16/629,171

(22) PCT Filed: Apr. 9, 2019
(86) PCT No.: PCT/US19/26657

§ 371 Date: Jan. 7, 2020

Related U.S. Application Data
(60) Provisional application No. 62/655,096, filed on Apr. 9, 2018.

(51) Int. Cl. B65G 1/137

(52) U.S. Cl. CPC B65G 1/1378; B65G 2209/04; B65G 1/1375

(57) ABSTRACT

A warehouse management system is provided using computing equipment and wireless communications between beacons providing worker locations in a warehouse. The system employs software running on the computing equipment to ascertain missing products for orders being shipped from packing stations in a product warehouse, and to assign workers with the shortest determined travel time over travel routes in the warehouse, to retrieve the missing product and move it to the packing station.

This application claims priority to U.S. Provisional Patent Application Ser. No. 62/655,096, filed on Apr. 9, 2018, which is incorporated herein in its entirety by this reference thereto.

### BACKGROUND OF THE INVENTION

### 1. Field of the Invention

The present invention relates generally to warehouse management systems employed for packaging of products for shipment. More particularly, it relates to an enhanced picking and packaging warehouse management system employing continuous real time location information in assigning and reassigning tasks for packaging workers and robots to continuously expedite the movement of products to final packaging of orders and thereby accelerate final shipment.

### 2. Prior Art

In recent years the significant and ongoing growth of online shopping and competition amongst providers has made the efficient packaging and shipment of the online orders for customers a priority. Such has resulted in a significant modernization of fulfillment centers where products are stored and retrieved through the introduction of robots along with human workers to retrieve and package products for shipment to customers.

Such distribution centers or product warehouses, in recent times, have come to face increasingly complex challenges in fulfilling customer orders. This has been a result of a changing profile for such orders which have changed from being oriented towards full pallet orders to full carton shipments, and from full carton shipments to individual item shipments. This change in order profiles for shipment has also resulted in a significant increase in operating costs for distribution center operations. This cost increase is due to the required tasks of order “picking” by employees and robots. Such picking during fulfillment requires that the individual items to be included in a shipment are gathered from a plurality of remote locations in the warehouse. During the gathering from multiple diverse warehouse locations, the individual items must then be transported to a single location in the warehouse where the shipment is packaged and sent.

With an ever increasing number of products located in ever increasing locations in such a warehouse, the tasks of order “picking” and related tasks of replenishing the remote locations where items are stored for picking, have become more manually intense per handling unit shipped. As a result, many companies have or are investing in a variety of technologies to reduce those costs. Such may include pick-to-light systems, “put walls,” the use of intelligent picking carts and increasingly mobile robots and even drones, among other technologies to locate and move the products from and to areas of the warehouse.

Conventionally, there are a number of control systems managing such warehouse systems, including a Warehouse Management System (WMS) and various control systems which, when deployed, are specific to each picking technology located within a warehouse. However, conventionally, there is no single system which manages workers and robots and the like involved in product picking and transport in the warehouse across technologies and pick-pack-ship processes. As a result of this shortcoming, significant efficiencies are lost or are unemployable.

The system herein disclosed provides for enhanced efficiency in such pick-pack-ship warehouses through the provision of a single software-enabled system platform which is adapted to direct operations across multiple technologies. The system herein thereby optimizes human and robot worker performance through the employment of intelligence from a real-time warehouse location system. This real time location system is configured to track both human workers and supporting equipment such as mobile robots and drones as their respective individual picking, packing, and shipping work is performed, and adjusting the assignment of worker tasks based on a determined real time location of each worker.

The forgoing examples of related art and limitations related therewith are intended to be illustrative and not exclusive, and they do not imply any limitations on the enhanced warehouse management system described and claimed herein. Various limitations of the related art are already known or will become apparent to those skilled in the art upon a reading and understanding of the specification below and the accompanying drawings.

An object of the present invention is to provide an improved warehouse management system for fulfillment warehouses engaged in pick-pack-ship type operations through the provision of enhanced assignment of tasks to workers based on an instantly determined real time location of each such human and robotic worker, thereby yielding the fastest movement of products from a starting or stored location to a desired destination location in the warehouse.

### SUMMARY OF THE INVENTION

The present invention provides a software and sensor enabled warehouse management system employing a single platform to control all of the underlying technology subsystems (pick-to-light, put walls, smart carts, robot, drones, etc.). In use, the system employs software running on a computing device and location sensors on workers operate to assign tasks to humans and/or robot workers to move products about the warehouse location for order fulfillment in the fastest determined time.

As noted, in conventional warehouse management systems (WMS) workers, which as used herein, may be human and/or any type of robotic workers, are employed in the movement of products about the warehouse. In such systems, in order to package a single order which includes one or a plurality of products for a shipment, workers are tasked to retrieve the ordered products from a warehouse storage location which is known as a “pick.” The products all have scanable codes or identifiers upon them such that when picked up, transported, and added to a shipment at a packing station, the system is informed by a scan communication. Upon reaching the location of the product in the warehouse, workers then transport the assigned product to a packaging station where it may be packaged for a shipment. In the WMS employed conventionally in warehouse and distribution centers, the WMS electronically communicates order (work) requirements for picking, to multiple subsystem components to initiate and make the assigned pick of a product. Based on the input from the WMS the subsystems control software directs the cart, robot, human, or other worker, to move to a location in the warehouse of the products, and execute the picks. Upon completion of this individual task, where the product has been retrieved and brought and scanned into to the packing station or bin for shipping, the software running to operate the individual subsystem components, will then send electronic confirmation of what work has been completed toward fulfilment of the products of an individual order, to the WMS.

This conventional WMS approach makes it impossible to fully optimize the pick-pack-ship process. This is because the human or robotic subsystem components executing picks for required products, are tasked their work based on only partial information about all the product location, the retriever location, and un congested travel pathway factors for humans and robots in the warehouse. Such factors impact the time duration to make the pick.

Using this conventional WMS directed subsystem approach, conventional WMS systems also cannot interleave multiple technologies into the pick process. For example, interleaving by combining pick cart picking operations with mobile robot pick operations, since each of the operative and software technologies operating the robots and cart pick operations are controlled by different onboard software control systems.

The integrated WMS system herein disclosed and described provides a solution to the shortcomings of prior art WMS systems. It does so through the provision of software running in electronic memory on a computer, which is configured to electronically communicate directly, with each of the humans and/or robots and direct product picking though a low level application programming interface (API) operatively engaged with each. This direct communication eliminates the need for the higher level control software for each of subsystem components required by conventional systems. Further it allows for using real time human and robot worker determined location information, which in turn allows for calculating more efficient product gathering tasks based on warehouse positions of both the human and robotic pickers and the required products and the routes to those products from each determined location of a human or robotic worker.

The system disclosed herein is configured to provide a single system in the WMS to continuously optimize the entire pick-pack-ship process. Using advanced algorithms, which continuously take into consideration the location of each subsystem picking component and/or human worker in a warehouse, the respective picking task assignments, and the location of the individual products in the warehouse relative to the location of the workers, and pathway conditions, the system optimizes each such assignment of work in a way not possible from the current approach. Such optimization for example may be provided by assigning work to a picking component or worker, in a currently known location in the warehouse using a pick cart to gather multiple products, based on what inventory for an order is available in a proximate to the current picking location of the workers. Further, the system includes the ability to substitute and/or insert new high priority orders/picks into the work queue for a pick cart, robot, or a human, based on their respective current known location, even after a previous task has already been assigned.

The disclosed WMS platform also makes it possible to combine the human and robotic picking activities. For example, currently subsystem pickers in a pick-to-light (PTL) system, employ visual light displays to communicate to workers pick information. Such information, for example, includes how many of each item to select from a stored location, to put in a carton or tote, can only work in areas supported with such PTL technology. Because of the cost implementing PTL, conventionally only a portion of total pick locations in many fulfillment warehouses are supported with this technology.

Consequently, using this conventional approach, a different set of workers, be they robotic or human, must perform picks in the PTL enabled warehouse locations from those workers performing picks in non-PTL locations. This requires an additional second step of combing picked products from the different workers and another step for shipment.

With a single platform system herein disclosed, which continuously monitors both worker and robotic picker locations relative to a product to be picked or transported, a worker can be directed to make picks in the PTL-enable zone and directed to then continue straight on (or vice versa) to the non-PTL locations, to pick the rest of the required products therefrom, significantly improving efficiencies. That benefit is enhanced with other forms of picking support technologies, such as workers which are mobile robots and drones.

Under the system herein, human workers warehouse locations, and the locations of mobile picking robots or equipment, are all continuously tracked using real-time locator technology, such as including “beacons” engaged to human and robotic workers. Such beacons employ wireless broadcasts to communicate their individual identifier which is associated to the worker, and their individual respective locations to a network of beacon receivers throughout a warehouse or distribution center. Thus, the current location of each worker, be they human or robotic, in the warehouse can be continuously determined relative to locations of products to be picked. Then the assigned tasks for picking or replenishment of products can be calculated based on product location, and estimated time for a pick by any respective picking person or robot, to assign or reassign a picking task to a picking person or robot, which can accomplish it the quickest. Further, by monitoring travel routes through the warehouse, picking tasks can be reassigned based on locations and clogged or unclogged routes through the warehouse.

The system herein, by electronically accessing this ongoing individual worker location information, provides a number of efficiencies and benefits. For example, if a worker using a pick cart finds that inventory needed for an order is not present in the assigned storage location, the worker can communicate the shortage to the WMS, and then continue working to pick other items/orders to be loaded to the cart.

Meanwhile, based on the input information from that first individual worker of a product shortage, a separate task will be created by the WMS wherein a secondary location for the product in the missing pick is determined. Once so determined, the system will then assign that pick task to a human or a robotic secondary worker, based on their proximity and possible route to that secondary location. This assignment is calculated from information from the real-time worker locator system, and calculations of time to reach the product location based on the routes from each worker location to the product in the secondary location. When the missing item has been picked from the secondary location, the secondary worker, such as human or a mobile robot or drone, will then be dispatched to meet the original order picker “in flight” based on his and their respective real-time location and movement, as indicated by the real-time locator system.

A key to this benefit is the concept of “pairing.” With the disclosed system technology, the system can specifically identify both resources (worker and robot/drone) which are involved in a retrieval task to ensure the right robot has met the right worker before the task to take the missing product from the robot/drone's storage area is communicated to the workers.

There are many other examples of this novel and preferred pairing capability enabled by the system herein. For example, rather than sending a robot/drone to pick and transfer an item missing from an order, by meeting the original order picker, the robot/drone could instead be sent with the picked missing item to a packing or exception handling area. This would be determined by calculating respective locations and the time over determined pathways to get to the respective locations. Here again, the pairing technology provides benefits, such as by ensuring that the robot/drone moves to the area where the pick cart carrying the carton/tote for that order is parked for packing. The cart is also tracked through the real time location system using wireless broadcasts from the cart to receivers for such broadcasts located in the warehouse.

Currently, in conventional WMS systems, “exception” handling for missing items follows a process without this pairing technology and are as such, slow and costly. A primary exception causing significant delays in such warehouses occurs when an item assigned to a human or robotic worker for a product pick, cannot be immediately transported to the worker packing the order to be shipped. This results in the cessation of movement of the order to be shipped while the missing item is located and transported to the packing station location to allow for final sealing of packaging and shipment of the order. Employing the pairing provided by the disclosed system herein, such exception-handling is resolved much faster by the immediate reassignment of the pick for the missing item to a worker proximate to the product needed, and the direct or hand-off transport of a missing item, to the packing station. Such significantly reduces a major bottleneck in the flow of ordered products to the packing station for order completion.

The real-time location information broadcast for each worker provided by the location system herein can be employed for warehouse enhancement in many other ways. For example, if a product needed for the packing station to complete an order is stored in multiple locations, the system, by ascertaining current locations of all workers in the warehouse, can ascertain if a given aisle or zone is currently crowded with workers. Using software adapted to the task of calculating a time duration from the worker location to the desired product location, the system determines the fastest route through the warehouse for a determined worker at a known location, from all other workers and their respective locations in the warehouse. The system will then dynamically assign how to move picking workers around congested areas of the warehouse, or to have one worker make a pick of a missing product through a non congested route and then meet a secondary order picker at a secondary storage location for a hand off, where the aisle/zone that is less congested. The secondary worker can then transport the item to the packing station to complete the order.

The system herein is also adapted with software configured to the task of parent-child tasks, for example in situations where a human or robotic worker in a pick-to-light area or working with a pick cart for gathering multiple items for a set of orders. If a missing item for a shipment at the packing station is required for retrieval and immediate transport to close out a stalled shipment, a mobile robot or drone can meet that worker en route and communicate the additional pick task (“child task”) to be completed in the flow of working on the other orders (parent tasks).

There are a number of other such examples of the operation and benefit of this system. In all the examples, it is the real-time, dynamic nature of the system, powered by access to real-time location data intelligence as to each worker location in the warehouse, and a determination of open and congested routes to a product for each worker, to optimize task picking assignments based on that information, which provides the substantial gains in operating performance. Thus, the product retrieval task can be assigned to the human or robotic worker which has been determined from their respective location, to have the fastest ability to the reach the product location, and move the product required to the packing station or hand it off to a worker moving toward the packing station.

With respect to the above description, before explaining at least one preferred embodiment of the herein disclosed warehouse management system in detail, it is to be understood that the invention is not limited in its application to the details of construction and to the arrangement of the steps in the system of the following description or illustrated in the drawings. The warehouse management system herein described is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for other enhanced warehouse management systems and for carrying out the several purposes of the present disclosed system. It is important, therefore, that the claims be regarded as including such equivalent construction and methodology insofar as they do not depart from the spirit and scope of the present invention. Further objectives of this invention will be brought out in the following part of the specification wherein detailed description is for the purpose of fully disclosing the invention without placing limitations thereon.

### BRIEF DESCRIPTION OF DRAWING FIGURES

FIG. 1 depicts a graphical depiction of an optimized warehouse management system (WMS) herein employing real-time location information of humans and robotic workers and calculations of times for each to complete the product retrieval tasks at hand.

FIG. 2 shows a flow chart example of one preferred mode of the management system disclosed herein using beacons communicating real-time robot and worker locations to receivers as related to product transport from storage to packing stations in a warehouse.

FIG. 3 depicts a conventional prior art warehouse management system which is task-oriented and lacking in location determination for task assignment of workers.

It should be noted the steps in the system herein may be reordered and that other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, any directional prepositions if employed, such as up, upwardly, down, downwardly, front, back, top, upper, bottom, lower, left, right and other such terms refer to the device or depictions as such may be oriented are describing such as it appears in the drawings and are used for convenience only. Such terms of direction and location are not intended to be limiting or to imply that the device or method herein has to be used or positioned with graphics in any particular orientation.

Further, computer and network terms such as network, database, electronic memory, computer, digital files, scanner, scanned identifier, and other terms are for descriptive purposes only, and should not be considered limiting, due to the wide variance in the art as to such terms depending on which practitioner is employing them. The system herein should be considered to include any and all manner of computing devices operatively engaged with electronic memory, software, firmware, operating systems, executable programs, files and file formats, databases, computer languages and networks and the like, as would occur to one skilled in the art in any manner as they would be described. The term worker or picker, includes both human and robotic workers.

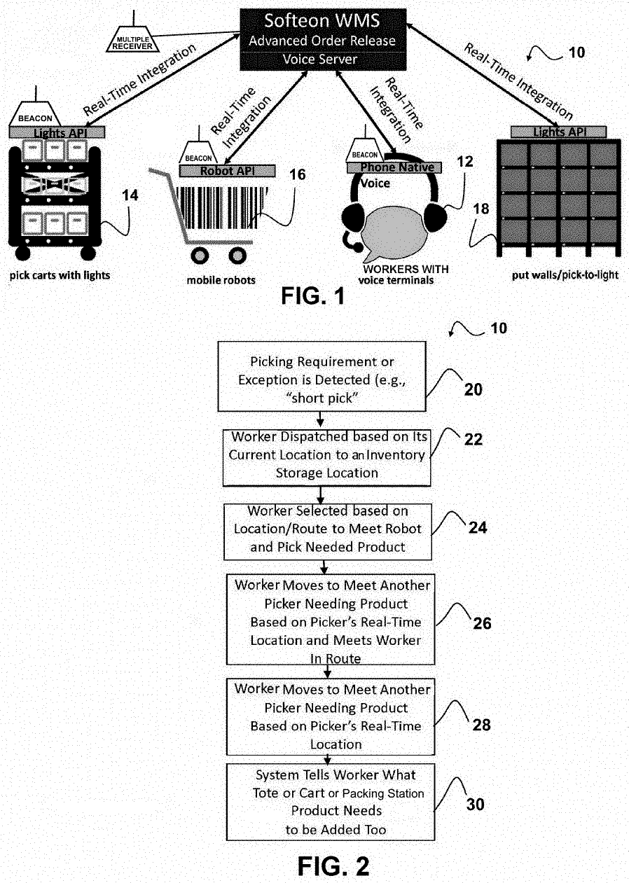

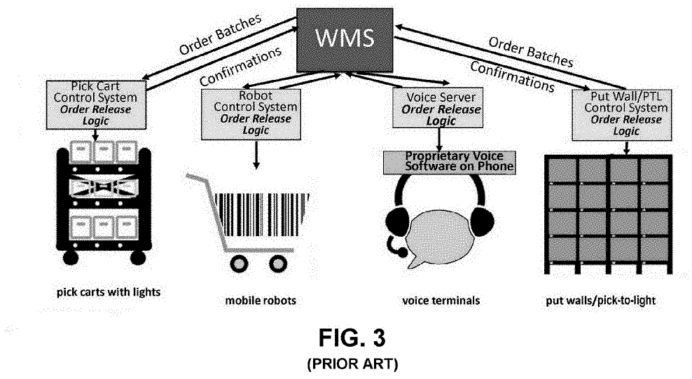

Now referring to drawings of the system of FIGS. 1-2 and prior art system of FIG. 3, there is seen in FIG. 1 a graphic depiction of the system 10 herein. In the system assigned and uncompleted product retrieval tasks and confirmation or failure to accomplish such are continuously directly communicated between the WMS system running in electronic memory on a computer with wireless communications capability to each picker or worker, from and between individual components and pickers operating in the system. Each product has a scannable identifier which when scanned will inform the system it has been retrieved, transported, and/or delivered to a packing station.

As shown, the location of each picker or worker in a warehouse holding products for shipment in known locations, is constantly provided to the system. This includes locations of a human worker 12 and/or robotic worker such as a robotic pick cart 14, robot 16, or pick to light 18. Such location determination is provided by a beacon engaged to each human or robotic worker, which continuously wirelessly transmits a beacon signal containing an identifier which is associated with the respective human or robotic worker.

Wireless signals communicated to the location software of the system 10 running in electronic memory of a computer, from beacon receivers for the wireless broadcast of each beacon on each worker, located in known physical locations in the warehouse, are employed by location determining software running on the system computer, to determine the exact current location in the warehouse, in real time, of each human or robotic worker. Such location software is adapted to the task of receiving the signals from one or a plurality of receivers, and calculating a location of each worker based on signal triangulation or similar calculations. Each wireless beacon transmission will communicate an identifier for the beacon which correlates to the individual worker, so the system can determine where each worker is positioned in real time, in the warehouse. By beacon is meant any electronic transmitter employing wireless transmissions such as radio or light transmission, which may be received by any of a plurality of beacon signal receivers for such transmissions, located in known positions along travel routes through the warehouse.

Using a map of travel routes through the warehouse, for both robotic and human workers which is stored in electronic memory, and the determined current locations of each human and robotic worker in the warehouse, the potential travel routes in the warehouse to any given product pick, are continually tracked by the WMS system 10. As noted, this ongoing location tracking and task assignment or reassignment based on the current location determined for each human and robotic worker is lacking in conventional prior art systems depicted in FIG. 3.

As noted above, in an example of the system 10 in operation in FIG. 2, a significant shortcoming of conventional systems is remedied by this real time current location tracking of all picking workers be they humans or robotic workers, and the fastest route calculation from such respective current locations to a required product at the packing station, in the assignment of product picking tasks. As shown, be it a product pick of multiple products needed for an order at a packing station, or the occurrence of a short pick 20 where a product to complete an order at the packing station is required, significant costs in time and efficiency occur in conventional systems. This is because the package being readied for shipment at the packing station cannot be finished because it is short by one or more products. Thus, the unshipped package and concurrently the worker trying to ship it from the packing station, are left in limbo while a remedy is sought to solve the short pick 20.

In the system 10 herein as shown in FIG. 2, a worker, be they human or robot, is dispatched 22 to retrieve the product causing the short pick and move it to the packing station requiring it. This dispatch 22 is based on the real-time determined current location 24 of the worker in the warehouse based on wireless transmissions to one or multiple beacon receivers in known locations, along the electronically stored routes of travel to products in the warehouse. Using a determined real-time location of each worker in the warehouse, the time calculation software running on the computer, adapted to the task of rendering a calculation of the time it will take for workers in known locations to get to a product location of the required product causing the short pick 20, along stored routes for the worker to travel, is determined. A retrieving worker is selected 24 from the workers in the warehouse, based on the shortest time calculation from a worker's current location, along the known routes through the warehouse to the product location, which is the subject of the short pick 20.

Assignment to move to the location along the travel routes is communicated to the worker wirelessly. In the case of human workers, this assignment may be a voice communication using a radio or the like, or a text communication to a viewable display readable by the human worker. In the case of robotic workers, this assignment to move to the product location and retrieve the required product for the packing station, can be sent by wireless communication to the robot computer operating to control the robotic worker movement through the warehouse. Such electronic communications are well known in the art.

The system 10 may also have traffic sensors or traffic monitors located in the warehouse, along the routes of travel which as noted are stored in electronic memory. Such traffic sensors may be electronic lights, cameras viewing traffic routes where congestion may be determined by camera signals showing pixels in routes of congestion being filled by workers or products, weight sensors along routes, or other traffic sensors adapted to communicate an electronic signals to the time calculation software of the system, where the signals are employed to determine congestion locations along known routes. The time required to traverse such congestion locations can be included by the time calculation software, in determining travel times to a product for workers to select a worker 24 to retrieve a product.

Additionally, the time it will take the chosen worker dispatched 22 to get to the product which is short picked, and move the product to the packing station to allow an order to be closed out, may also be included by the time calculation software in determining a worker 24 to retrieve a product.

In a next step, once the missing product has been retrieved by the assigned worker such as a robot or human, the assigned worker can move to transport the product 26 to the packing station needing the short pick 20 which is causing the order to be delayed from shipment. Alternatively, if the short pick 20 resulted from a first worker signaling during their respective assignment to retrieve a missing product, that they could not retrieve the missing product, that first worker assigned to retrieve the missing product causing the short pick, can be assigned to meet a secondary worker who will be assigned to retrieve the missing product from a secondary location 28. The secondary worker can pass the product to the first worker for transport to the packing station.

Either route is achievable because the system herein continuously tracks and knows the respective location of each worker, be they human or a robotic worker, along known pathways within the warehouse, and employees a known and electronically stored physical location of each product, to continuously determine and assign and reassign each such human or robotic worker, to pick a product based on the product known location and the worker current location. Further, as noted, the system 10 can assign the human or robotic worker retrieving a missing pick product, to meet a secondary worker or picker 28 based on the real-time location of each, so that the product causing the missing pick, may be handed off to the secondary worker who is currently determined as moving to or toward the packing station which is missing one or more products.

Finally, once the missing product or products have been retrieved by the assigned human or robotic worker, and either directly transported to the packing station with the open order needing it, or handed off to another human or robotic worker going to or toward that packing station, to thereby conclude the products needed to ship the order, the system is notified the order is complete 30. Thus, the system 10 using real-time locations of all human or robotic pickers in the warehouse, known routes through the warehouse, and determined congested route areas, can continuously assign picking tasks and direct hand offs or direct transports to packing station having the open order, using worker current location and time calculations for each human or robotic worker, which can also include calculations on route traffic therebetween.

While all of the fundamental characteristics and features of the warehouse management system herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that upon reading this disclosure and becoming aware of the disclosed novel and useful warehouse management system herein, that various substitutions, modifications, and variations may occur to and be made by those skilled in the art without departing from the spirit or scope of the invention. Consequently, all such modifications and variations and substitutions, as would occur to those skilled in the art are considered included within the scope of the invention as defined by the following claims.

What is claimed is:

1. A warehouse management system comprising:
a computer having electronic memory;
storage locations for products stored in said warehouse being stored in said electronic memory;
packing station locations for packaging orders for said products being stored in electronic memory;
travel routes through said warehouse running between said locations for said products and said packing stations being stored in electronic memory;
said computer running software warehouse management software for the task of communicating retrieval assignments to workers in the warehouse, said retrieval assignments tasking respective said workers to move along said travel routes to a respective storage location of a product which is required, and transport the product which is required, along said travel routes to a said packing station location;
beacons engaged to each of said workers, said beacons wirelessly broadcasting a beacon signal, said beacon signal including a beacon identifier associated with a respective individual said worker;
receivers positioned in said warehouse which receive the beacon signal from said beacons, said receivers communicating each respective beacon signal received from a said beacon, to said computer;
location determining software running on said computer, said location determining software employing said beacon signal from said receivers to calculate a worker location of said workers upon said travel routes;
wireless communications equipment for communication of assignment messages from said computer to said workers, and
travel time calculation software running on said computer, said time calculation software calculating a time duration required for movement of respective workers from their determined respective worker location, to the storage location of the product which is required, wherein a wireless communication of an assignment message is communicated to a respective said worker having a determined shortest said time duration along said travel routes to said storage location, to retrieve the required product from said storage location and move it to said packing station.

2. The warehouse management system of claim 1, additionally comprising:
traffic sensors for determining slowed travel times through congestion locations on said routes through said warehouse; and
said travel time calculation software running on said computer, including said slowed travel times through said congestion locations in calculating said time duration required for movement of respective workers from their determined respective worker location, to the storage location of the product.

3. The warehouse management system of claim 1, additionally comprising:
said location determining software running on said computer concurrently employing said beacon signal from said receivers to calculate secondary worker locations of secondary workers traveling upon said travel routes toward said packing station; and
said wireless communication of said assignment message to said worker to retrieve the required product from said storage location and move it to said packing station includes directions to a secondary location of said secondary worker and instructions to give the required product to said secondary worker for transport to said packing station.

4. The warehouse management system of claim 2, additionally comprising:
said location determining software running on said computer concurrently employing said beacon signal from said receivers to calculate secondary worker locations of secondary workers traveling upon said travel routes toward said packing station; and
said wireless communication of said assignment message to said worker to retrieve the required product from said storage location and move it to said packing station includes directions to a secondary location of said secondary worker and instructions to give the required product to said secondary worker for transport to said packing station.

5. A method for warehouse management employing a computer with electronic memory, beacons transmitting electronic signals engaged to and identifying each or a plurality of workers, receivers for said electronic signals in operative communication with said computer, and wireless communications equipment for messages from the computer to the workers, comprising the steps of:
inputting storage locations to the electronic memory for a plurality of products stored in a warehouse;
inputting packing station locations within said warehouse to said electronic memory;
inputting travel routes through said warehouse running between said locations for said products and said packing stations to said electronic memory;
running warehouse management software on said computer and determining missing products from orders being packed at said packing stations;
communicating said electronic beacon signals from said beacons which are received by said receivers, to said computer;
using location determining software running on said computer for each worker's location upon said travel routes;
using travel time calculation software running on said computer to calculate a time duration required for movement of respective workers from their respective location upon said travel routes to a storage location of said missing products; and
wirelessly communicating an assignment message to a respective said worker having a determined shortest said time duration along said travel routes, to said storage location, to retrieve the required product from said storage location and move it to said packing station.
